(19) United States
(12) Patent Application Publication
(10) Pub. No.: US 2014/0358509 A1
(43) Pub. Date: Dec. 4, 2014

(54) Systems and Methods for Presenting Data Associated with a Power Plant Asset

(71) Applicant: General Electric Company, Schenectady, NY (US)

(72) Inventors: Pavan Kumar Singh Thakur, Hyderabad (IN); Pradyumna Ojha, Hyderabad (IN); Veera Paparao Bolla, Hyderabad (IN); Balajose Goli, Hyderabad (IN); Christina Ann Romanik, Salem, VA (US)

(21) Appl. No.: 13/908,509

(22) Filed: Jun. 3, 2013

(51) Int. Cl. G05B 17/02

(52) U.S. Cl. CPC G05B 17/02
USPC 703/7

(57) ABSTRACT

Certain embodiments may include systems and methods for presenting data associated with a power plant configuration tool. In one embodiment, a method may include creating configurations of inter-object relationships among a plurality of asset objects of a massive object model, loading the object model, changing values of data member attributes of at least one of the asset objects with a plant configuration tool without changing software code of plant configuration tool, saving the configurations in a permanent storage location, and retrieving the configurations for display to a user.

### TECHNICAL FIELD

This disclosure generally relates to object models, and in particular to systems and methods for presenting data associated with a power plant asset.

### BACKGROUND

Conventional power plant configuration software tools that support control system software frameworks may need to load from one or more database servers a relatively massive object model that includes all the configurable data associated with the configurable assets (systems, equipment and devices) of a distributed control system (DCS) of the power plant. New power plant configuration tools can sometimes be created by logically setting up certain technical relationships among the various asset objects of the object model that represent systems and equipment of the power plant. Such tools may need to provide certain features to change the values of the various data member attributes of these objects which are interlinked logically with each other without changes to the software tool's code. However, this becomes relatively more difficult when the data object model is maintained by different functional teams with independent software release schedules.

### BRIEF DESCRIPTION OF THE DISCLOSURE

Some or all of the above needs may be addressed by certain embodiments of the disclosure. According to an example embodiment, there is disclosed a method for presenting data associated with a power plant configuration tool. The method may comprise creating configurations of inter-object relationships among a plurality of asset objects of a massive object model, loading the object model, changing values of data member attributes of at least one of the asset objects with a plant configuration tool without changing software code of plant configuration tool, saving the configurations in a permanent storage location, and retrieving the configurations for display to a user.

The power plant configuration tool may be operable to allow schema changes to the object model structure without changes in the tool code and may be operable to allow schema changes to the inter-object relationships without changes in the tool code. In addition, plant configuration tool may be operable to read any compound attribute of an asset object from the server database and save changes to the compound attribute back to the server database. Further, the plant configuration tool may be operable to support compound attributes to any level of nesting, attributes of basic and reference types, and array of compound properties. The plant configuration tool may be operable to function without knowledge of type definition of the compound attributes or nested properties during the code build time.

According to another embodiment of the invention, there is disclosed a method for presenting data associated with a power plant configuration tool. The method may comprise defining schema of objects as XML schema definitions, using the XML schema definitions to generate class definitions, generating a data model library using the XML schema definitions, wherein creating a change in the data model schema creates a new data model library for the plant configuration tool, loading the data model library at runtime, running recursive logic to extract type definitions of all objects from the loaded data model library, reading type information of an asset and asset attributes, traversing through children of each asset and dynamically creating an object for each type and its child hierarchy, wherein a resulting object model consists of the objects, their attributes, object hierarchies and inter-object relationships and displaying the attributes in a property grid.

The plant configuration tool may be operable to use an expandable type converter to define a user interface that supports multi-hierarchy properties and multi-hierarchy array properties, wherein the type converter is attached as an attribute to a property descriptor definition of a compound property. The schema definitions of the objects may be stored in XSD files. The class definitions may comprise the class definitions of .NET framework. Further, objects with compound properties can be inside compound properties and objects with compound properties may be an array.

According to yet another embodiment of the invention, there is disclosed a computer-readable medium having computer-executable instructions for performing acts that may comprise creating configurations of inter-object relationships among a plurality of asset objects of a massive object model, wherein the object model comprises all configurable data of configurable assets of a data control system of a power plant, loading, on a client computing device from a database server, the object model, changing values of data member attributes of at least one of the asset objects with a plant configuration tool without changing software code of plant configuration tool, saving the configurations in a permanent storage location, and retrieving the configurations for display to a user.

Other embodiments, features, and aspects of the disclosure are described in detail herein and are considered a part of the claimed disclosure. Other embodiments, features, and aspects can be understood with reference to the following detailed description, accompanying drawings, and claims.

### BRIEF DESCRIPTION OF THE FIGURES

References will now be made to the accompanying figures, which are not necessarily drawn to scale, and wherein:

FIG. 1 is a schematic block diagram of an exemplary system architecture for implementing support in a user interface of compound properties of any data type of objects, according to certain embodiments of the disclosure.

FIG. 2 is a flowchart illustrating an example method for implementing support in a user interface of compound properties of any data type of objects, according to certain embodiments of the disclosure.

### DETAILED DESCRIPTION OF THE FIGURES

Example embodiments of the disclosure now will be described more fully hereinafter with reference to the accompanying drawings, in which some, but not all embodiments are shown. Indeed, the disclosure may be embodied in many different forms and should not be construed as limited to the embodiments set forth herein; rather these embodiments are provided so that this disclosure will satisfy applicable legal requirements. Like numbers refer to like elements throughout.

As an overview, software design of the plant configuration tool can be very robust and capable to accommodate schema changes to an object model structure, changes to attributes of each object, and changes to their inter-object relationships without modification of the tool code. Certain embodiments of the disclosure can be related to the attributes of asset objects. Attributes of an object may be understood as a name value pair that describes a characteristic of an object. An attribute can be of any type, a basic or an object reference type. A compound attribute of an asset object is an attribute that may contain one or more attributes of different types and even array types. Accordingly, compound attributes may have nested attributes. Further, a nested attribute itself may be a compound attribute consisting of its own nested attributes of different types. Certain embodiments of the disclosure can provide a mechanism in a user interface of a configuration tool to read any asset's compound attributes from a server database and save it back to the server database. Certain embodiments of the disclosure can function in a generic manner without the need to know about the type definition of the compound property or its nested properties during the code build time. The tool can support compound properties to any level of nesting, attribute of any type and also array of compound properties.

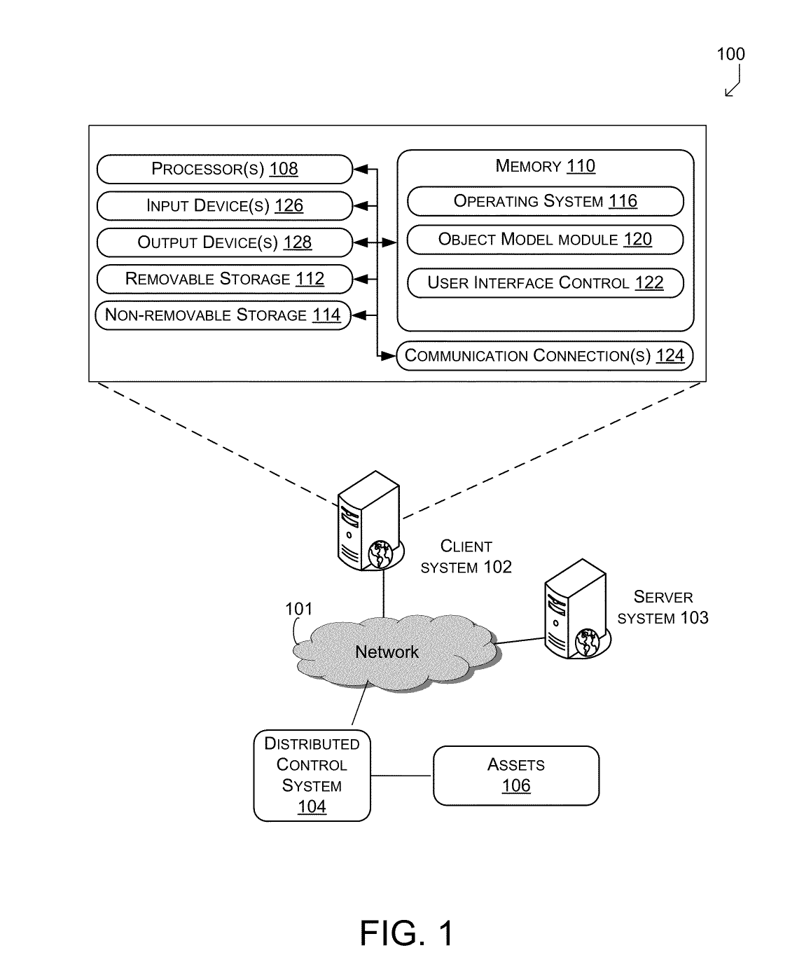

FIG. 1 depicts an exemplary system 100 that may implement a power plant configuration tool that supports in a user interface compound properties of any data type of objects representing power plant assets, according to certain embodiments of the disclosure.

As shown in FIG. 1, a distributed control system (DCS) 104 may be operable to manage power plant assets 106. The assets 106 may be the systems, equipment, and devices used in the operation of a power plant. The power plant configuration tool may provide features for site engineers to create new configurations by logically setting up technical relationships among the various asset objects of the object model that represent the systems/equipment of the power plant. The massive object model that comprises of the all the configurable data of all the configurable assets (systems, equipment and devices) of the DCS control system 104 of a power plant may be stored on database servers 103.

A client computing system 102 may communicate with the DCS 104 or server computers systems 103 via a network 101. The network 101 may include, but are not limited to, personal area networks (“PANs”), wired local area networks (“LANs”), wireless local area networks (“WLANs”), wireless wide area networks (“WWANs”), and so forth. Alternatively, direct communication connections may exist between the client computing system 102 and with the DCS 104 or the servers 103.

The computing system 102 may include one or more computing devices, which may include, but are not limited to, a processor 108 capable of communicating with a memory 110. The processor 108 may be implemented as appropriate in hardware, software, firmware, or combinations thereof. Software or firmware implementations of the processor 108 may include computer-executable or machine-executable instructions written in any suitable programming language to perform the various functions described. The computing system 102, via one or more software programs or modules described in greater detail below, may perform a number of functions to implement or facilitate the processes described herein.

A memory 110 may store program instructions that are loadable and executable on the processor 108, as well as data generated during the execution of these programs. Depending on the configuration and type of computing system 102, a memory 110 may be volatile (such as random access memory (RAM)) and/or non-volatile (such as read-only memory (ROM), flash memory, etc.). In some embodiments, the computing system 102 may also include additional removable storage 112 and/or non-removable storage 114 including, but not limited to, magnetic storage, optical disks, and/or tape storage. The disk drives and their associated computer-readable media may provide non-volatile storage of computer-readable instructions, data structures, program modules, and other data for the devices. In some implementations, the memory 110 may include multiple different types of memory, such as static random access memory (SRAM), dynamic random access memory (DRAM), or ROM.

The memory 110, removable storage 112, and non-removable storage 114 are all examples of computer-readable storage media. For example, computer-readable storage media may include volatile and non-volatile, removable and non-removable media implemented in any method or technology for storage of information such as computer-readable instructions, data structures, program modules, or other data. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVDs) or other optical storage, magnetic cassettes, magnetic tapes, magnetic disk storage or other magnetic storage devices, or any other medium which can be used to store the desired information and which can be accessed by the devices. Combinations of any of the above should also be included within the scope of computer-readable media.

The computing system 102 may also contain one or more communication connections 124 that allow the devices to communicate with devices or equipment capable of communicating with a computing device. The connections can be established via various data communication channels or ports, such as USB or COM ports, to receive connections for cables connecting the devices, e.g., control devices, to various other devices in an IO network. Devices on the IO network can include communication drivers such as Ethernet drivers that enable the devices to communicate with other devices on the IO network. According to various embodiments, the communication connections 124 may be established via a wired and/or wireless connection on the IO network. The computing system 102 may also include one or more input devices 126, such as a keyboard, mouse, pen, voice input device, and touch input device. The computing system 102 may also include one or more output devices 128, such as a display, a printer, and speakers.

In other embodiments, however, computer-readable communication media may include computer-readable instructions, program modules, a non-transitory medium, or other data transmitted within a data signal, such as a carrier wave, or other transmission. As used herein, however, computer-readable storage media does not include computer-readable communication media.

Turning to the contents of the memory 110, the memory 110 may include, but is not limited to, an operating system (OS) 116 and one or more application programs or modules for implementing the features and aspects disclosed herein.

The object model module 120 may be configured to create the object model. The module 120 may be configured to receive instructions for creating new configurations by logically setting up the technical relationships among the various asset objects that represent systems/equipment of the power plant and to change the values of the various data member attributes of these objects which are interlinked logically with each other.

In one embodiment, the schema of the objects may be defined as XML schema definitions (XSDs). The XSDs may be used to generate the class. These class definitions may be built to generate a data model library. In an embodiment, the object generation layer of the configuration tool can load the data model library at runtime. After loading the data model library at runtime, recursive logic may be run to extract the type definitions of all the objects and an object can be created dynamically for each type and its child hierarchy. The resulting object model may include the objects, their attributes, objects hierarchies, and inter-object relationships. The objects in the object model may be created to adapt to any kind of schema changes to the object data model schema. Thus, in this manner, certain embodiments of the disclosure may have the technical effect of generating a new data model library whenever there is a change in the data model schema.

Further, turning to the contents of the memory 110, the user interface control 122 may be used in the display of the object with the compound attributes. A user interface that supports multi-hierarchy properties and multi-hierarchy array properties may be defined by an expandable type converter and attached as an attribute to the property descriptor definition of a compound property. Thus, in this manner, certain embodiments of the disclosure may have the technical effect of displaying compound attributes by a property grid. The power plant configuration tool may be configured to comprise the object model module 120 and the interface control 122.

These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of the blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the block or blocks.

One or more components of the systems and one or more elements of the methods described herein may be implemented through a module or application program running on an operating system of a computer. They also may be practiced with other computer system configurations, including handheld devices, multiprocessor systems, microprocessor-based or programmable consumer electronics, mini-computers, main computers, etc.

Application programs that are components of the systems and methods described herein may include routines, programs, components, data structures, etc., that implements certain abstract data types and perform certain tasks or actions. In a distributed computing environment, the application program (in whole or in part) may be located in local memory or in other storage. In addition, or in the alternative, the application program (in whole or in part) may be located in remote memory or in storage to allow for circumstances where tasks are performed by remote processing devices through a communication network 101.

The example system shown in FIG. 1 is provided by way of example only. Numerous other operating environments, system architectures, and device configurations are possible. Accordingly, embodiments of the present disclosure should not be construed as being limited to any particular operating environment, system architecture, or device configuration.

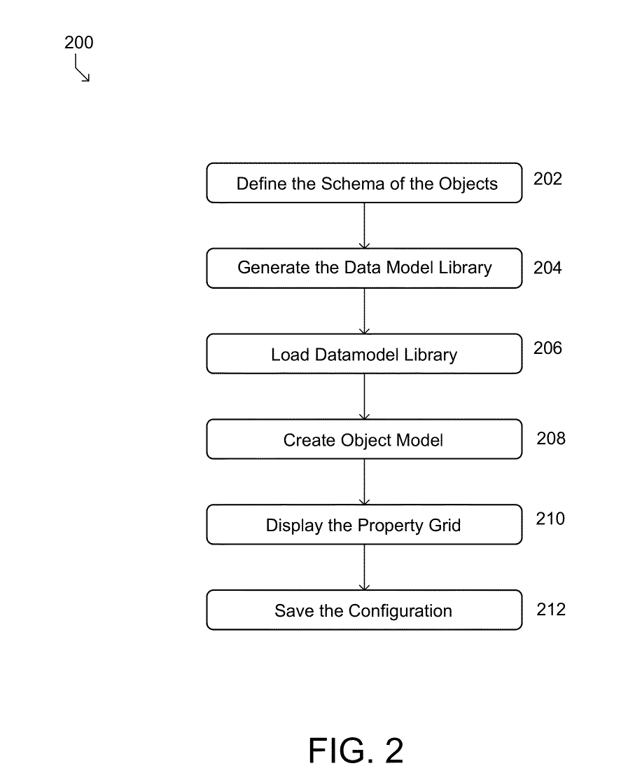

FIG. 2 is a flow diagram indicating an exemplary method 200 for implementing support in a user interface of compound properties of any data type of objects, according to certain embodiments of the disclosure. Portions of the method 200 may be implemented using the object model module 120 or the user interface control 122 shown in FIG. 1.

At operation block 202, the method 200 may define the schema of the object model. The development team that creates the data model structure may define the schema of the objects as XML schema definitions (XSDs) such that the schema definition of the objects may reside in the XSD files. The XSDs may be used to generate the class definitions for a framework such as .NET in a programming language such as C#.

In operation block 204, the method 200 may generate the data model library. The class definitions may be built to generate a data model library such that whenever there is a change in the data model schema, there may be a new data model library generated for the client tool. The object model for the plant assets that may be created at the client tool side can be called the plant information model. The objects in the model may be called plant information model objects.

At operation block 206, the data model library may be loaded onto the client computer system. In one embodiment, a design feature in the plant information model object generation layer of the configuration tool may be to load the data model library at runtime.

In operation block 208, the method 200 may create the object model. After loading the data model library at runtime, recursive logic may be ran to extract the type definitions of all the objects from the loaded data model library assembly. This step may involve reading the type information of an asset and its attributes and traversing through the children of each of the assets. Using a framework mechanism, such as .NET REFLECTION, an object is created dynamically for each type and its child hierarchy. The result of this logic may be an object model consisting of the objects, their attributes, objects hierarchies, and inter-object relationships. In this manner, certain embodiments of the disclosure may have the technical effect of creating and managing the plant configuration in the tool. The objects in the object model created with this mechanism can make the tool completely flexible and adaptable to any kind of schema changes to the object data model schema as the objects may be created dynamically on reading the type from the data model library.

In operation block 210, the method 200 may be used in the display of the object in a property grid. The runtime object creation mechanisms may be used such as those supported by .NET REFLECTION. The compound attributes may be displayed in a property grid such as that provided by a framework such as .NET. The expandable type converter may be used to define the user interface that support multi-hierarchy properties and multi-hierarchy array properties. This type converter may then be attached as an attribute to the property descriptor definition of a compound property. In this manner, certain embodiments of the disclosure may have the technical effect of having a tool that can support compound attributes inside a compound attribute which means there can be any level of nested compound attributes and a compound attribute can be an array.

At operation block 212, the configurations may be saved in permanent storage locations for later retrieval.

The example method 200 shown in FIG. 2 is provided by way of example only. Numerous other operating environments, system architectures, and device configurations are possible. Further, steps may be performed in any order or omitted. Accordingly, embodiments of the present disclosure should not be construed as being limited to any particular operating environment, system architecture, or device configuration.

This written description uses examples to disclose certain embodiments of the disclosure, including the best modes, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A method for presenting data associated with a power plant configuration tool, the method comprising:
creating configurations of inter-object relationships among a plurality of asset objects of a massive object model, wherein the object model comprises all configurable data of configurable assets of a data control system of a power plant;
loading, on a client computing device from a database server, the object model;
changing values of data member attributes of at least one of the asset objects with a plant configuration tool without changing software code of plant configuration tool;
saving the configurations in a permanent storage location; and
retrieving the configurations for display to a user.

2. The method of claim 1, wherein the plant configuration tool is operable to allow schema changes to the object model structure without changes in the tool code.

3. The method of claim 1, wherein the plant configuration tool is operable to allow schema changes to the inter-object relationships without changes in the tool code

4. The method of claim 1, wherein the plant configuration tool is operable to read any compound attribute of an asset object from the server database.

5. The method of claim 4, wherein the plant configuration tool is operable to save changes to the compound attribute back to the server database.

6. The method of claim 1, wherein the plant configuration tool is operable to support compound attributes to any level of nesting, attributes of basic and reference types, and array of compound properties.

7. The method of claim 1, wherein the plant configuration tool is operable to function without knowledge of type definition of the compound attributes or nested properties during the code build time.

8. A method for presenting data associated with a power plant configuration tool, the method comprising:
defining schema of objects as XML schema definitions;
using the XML schema definitions to generate class definitions;
generating a data model library using the XML schema definitions, wherein creating a change in the data model schema creates a new data model library for the plant configuration tool;
loading the data model library at runtime;
running recursive logic to extract type definitions of all objects from the loaded data model library;
reading type information of an asset and asset attributes;
traversing through children of each asset and dynamically creating an object for each type and its child hierarchy, wherein a resulting object model consists of the objects, their attributes, object hierarchies and inter-object relationships; and
displaying the attributes in a property grid.

9. The method of claim 8, further comprising using an expandable type converter to define a user interface that supports multi-hierarchy properties and multi-hierarchy array properties;
wherein the type converter is attached as an attribute to a property descriptor definition of a compound property.

10. The method of claim 8 wherein the schema definitions of the objects are stored in XSD files.

11. The method of claim 8 wherein the class definitions comprise the class definitions of .NET framework.

12. The method of claim 8 wherein objects with compound properties can be inside compound properties.

13. The method of claim 8 wherein objects with compound properties may be an array.

14. A computer-readable medium having computer-executable instructions for performing acts comprising:
creating configurations of inter-object relationships among a plurality of asset objects of a massive object model, wherein the object model comprises all configurable data of 1 configurable assets of a data control system of a power plant;
loading, on a client computing device from a database server, the object model;
changing values of data member attributes of at least one of the asset objects with a plant configuration tool without changing software code of plant configuration tool;
saving the configurations in a permanent storage location; and
retrieving the configurations for display to a user.

15. The computer-readable medium of claim 14, wherein the plant configuration tool is operable to allow schema changes to the object model structure without changes in the tool code.

16. The computer-readable medium of claim 14, wherein the plant configuration tool is operable to allow schema changes to the inter-object relationships without changes in the tool code

17. The computer-readable medium of claim 14, wherein the plant configuration tool is operable to read any compound attribute of an asset object from the server database.

18. The computer-readable medium of claim 17, wherein the plant configuration tool is operable to save changes to the compound attribute back to the server database.

19. The computer-readable medium of claim 14, wherein the plant configuration tool is operable to support compound attributes to any level of nesting, attributes of basic and reference types, and array of compound properties.

20. The computer-readable medium of claim 14, wherein the plant configuration tool is operable to function without knowledge of type definition of the compound attributes or nested properties during the code build time.
